(19) United States
(12) Patent Application Publication
(10) Pub. No.: US 2024/0002257 A1
(43) Pub. Date: Jan. 4, 2024

(54) OFFSHORE WIND POWER GENERATION-SEAWATER DESALINATION-WATER ELECTROLYSIS COMPLEX SYSTEM

(71) Applicant: KOREA INSTITUTE OF OCEAN SCIENCE & TECHNOLOGY, Busan (KR)

(72) Inventors: Ho Saeng LEE, Sokcho-si (KR); Ho JI, Gangwon-do (KR); Hyeon Ju KIM, Sejong (KR)

(21) Appl. No.: 18/466,214

(22) Filed: Sep. 13, 2023

Related U.S. Application Data
(63) Continuation of application No. PCT/KR2022/005676, filed on Apr. 20, 2022.

(30) Foreign Application Priority Data
Apr. 21, 2021 (KR) 10-2021-0051988

(51) Int. Cl. C02F 1/04; C02F 1/16; C02F 1/28; C02F 1/44; C25B 1/04; C25B 9/23; C25B 9/67; F03D 9/25

(52) U.S. Cl. CPC C02F 1/047; C02F 1/16; C02F 1/28; C02F 1/447; C25B 1/04; C25B 9/23; C25B 9/67; F03D 9/25; C02F 2103/08

(57) ABSTRACT

Proposed is a complex system of offshore wind power generation, seawater desalination, and water electrolysis. The system may include a wind power generator which generates electric power in such a manner that blades are rotated by wind power. The wind power generator may include a cooler for preventing a overheating phenomenon caused by electric power generation. The system may also include a seawater desalination apparatus which desalinates seawater by using hot water discharged after heat exchange through the cooler. The system may further include a water electrolysis apparatus which receives fresh water produced by the desalination apparatus and a heat source discharged therefrom to use the fresh water and heat source for producing hydrogen. A part of a heat source discharged from the water electrolysis apparatus after the production of hydrogen may be heat-exchanged with the cooler, and heat-exchanged with the heat source discharged from the desalination apparatus.

### CROSS REFERENCE TO RELATED APPLICATIONS

This application is a continuation application, and claims the benefit under 35 U.S.C. § 120 and § 365 of PCT Application No. PCT/KR2022/005676 filed on Apr. 20, 2022, which claims priority to Korean Patent Application No. 10-2021-0051988 filed on Apr. 21, 2021, each of which are hereby incorporated by reference in their entirety.

### BACKGROUND

### Technical Field

The present disclosure relates to a system capable of utilizing a waste heat source of offshore wind power generation, and more particularly, to a complex system of offshore wind power generation, seawater desalination, and water electrolysis.

### Description of Related Technology

Natural energy includes wind power, water power (tidal power), wave power, solar cell energy, and solar heat, etc. Among them, a facility for wind power may be installed vertically with respect to the ground, so an installation area of the facility is smaller than the installation areas of other natural energy generation facilities. Moreover, such a wind power facility can be used day and night.

### SUMMARY

One aspect is a complex system of offshore wind power generation, seawater desalination, and water electrolysis which can produce water through a seawater desalination method and can produce hydrogen and oxygen through a low-temperature water electrolysis method by utilizing a hot water waste heat source discarded after heat exchange in a cooler of an offshore wind power generator.

Another aspect is a complex system of offshore wind power generation, seawater desalination, and water electrolysis according to one embodiment of the present disclosure includes: a wind power generator which generates electric power in such a manner that blades are rotated by wind power, the wind power generator comprising a cooler for preventing a overheating phenomenon caused by the electric power generation; a seawater desalination apparatus which desalinates seawater by using hot water discharged after heat exchange through the cooler; and a water electrolysis apparatus which receives fresh water (ultrapure water) and a heat source discharged after desalination of seawater in the seawater desalination apparatus to use the fresh water and heat source for producing hydrogen, wherein a part of a heat source discharged from the water electrolysis apparatus after the production of hydrogen is heat-exchanged with the cooler and is heat-exchanged with the heat source discharged from the seawater desalination apparatus. In addition, electricity generated by the wind power generator may be used as electric power supplied for the seawater desalination apparatus and the water electrolysis apparatus.

In addition, temperatures of waste heat (hot water) and seawater used in the complex system of offshore wind power generation, seawater desalination, and water electrolysis according to the embodiment of the present disclosure may be preset according to a surrounding environment (a wind power generation capacity and a region, etc.).

In addition, a seawater desalination method used in the desalination apparatus included in the complex system of offshore wind power generation, seawater desalination, and water electrolysis according to the embodiment of the present disclosure may be one of an adsorption desalination (AD) method, a membrane distillation (MD) method, and an evaporation method (MED, MSF, MVR).

In addition, a hydrogen production method used in the water electrolysis apparatus included in the complex system of offshore wind power generation, seawater desalination, and water electrolysis according to the embodiment of the present disclosure may be a low temperature water electrolysis (PEM) method.

According to one embodiment of the present disclosure, it is possible to provide the complex system of offshore wind power generation, seawater desalination, and water electrolysis which can produce water through a seawater desalination method and can produce hydrogen and oxygen through a low-temperature water electrolysis method by utilizing a hot water waste heat source discarded after heat exchange in the cooler of an offshore wind power generator.

The effects of the present disclosure are not limited to the effects mentioned above, and other effects not mentioned will be clearly understood by those skilled in the art from the description of the claims.

### BRIEF DESCRIPTION OF THE DRAWINGS

FIG. 1 is a diagram illustrating the configuration of a heat source system utilizing a waste heat source (an unutilized heat source) of a complex system of offshore wind power generation, seawater desalination, and water electrolysis, according to one embodiment of the present disclosure.

FIG. 2 is a diagram illustrating the system configuration of a membrane distillation (MD) method and an evaporation method (multi-effect distillation (MED), multi-stage flash distillation (MSF), mechanical vapor recompression (MVR)) among seawater desalination methods applicable to the present disclosure, and the inlet temperature and outlet temperature of a PEM water electrolysis apparatus.

FIG. 3 is a diagram illustrating the system configuration of an adsorption desalination (AD) method among seawater desalination methods applicable to the present disclosure and the inlet temperature and outlet temperature of the PEM water electrolysis apparatus.

### DETAILED DESCRIPTION

It is disclosed in JP Publication Nos. 2004-537668 and JP 2000-202441 that wind power generation is used for power of a pressure pump for treating untreated water or seawater with a reverse osmosis plant. JP Publication No. 2004-290945 discloses that wind power generation is used as power for a pump that pumps up seawater for the purpose of desalination of seawater. In addition, JP Publication No. 2005-069125 discloses that wind power generation is used as electric power to produce hydrogen by electrolyzing fresh water obtained from a seawater desalination apparatus.

There is also an attempt to desalinate seawater by directly using wind power as a power source. JP Publication No. 2003-083230 discloses an osmotic seawater desalination apparatus in which an air compressor is connected to a windmill shaft and compressed air from a compressed air tank is applied to seawater to produce fresh water from the seawater. In addition, JP publication No. 2005-521557 discloses a wind-powered seawater desalination plant as a means for sending seawater to an evaporation pipe for a seawater desalination plant.

Current commercial large-scale wind power generation facilities are connected to existing transmission lines regardless of land or sea to transmit generated electricity in real time to be used. Since the sea has no obstacles and is a suitable environment for windmills, the sea is relatively free from problems related to the location of wind power generation facilities. Accordingly, recently, the installation of offshore wind power generation facilities is increasing.

The sea is very advantageous to efficiently obtain installation power for offshore wind power generation facilities. However, in the case of installing a wind power generation facility on the sea, it is necessary to establish a new power transmission facility in the location of the sea that is connected to an existing power transmission line on land, and the installation of the wind power generation facility is a large-scale construction, resulting in excessive installation costs, and this problem was acting as an obstacle to the dissemination of an offshore wind power generation facility.

In addition, power generation through a wind power generation facility is caused by wind, and power generation is made regardless of demand, and thus in the conventional method of supplying electricity to consumers in real time, the wind power generation facility is used indispensably in combination with other power generation means that are easy to be controlled, and this was also an obstacle to disseminate the facility.

For the reasons described above, even though it is known that power can be efficiently obtained when a wind power generation facility is installed on the sea, it is a current situation that the offshore wind power generation facility has not been sufficiently disseminated.

It is easy to think that natural energy such as wind power described above is an appropriate energy source because the natural energy is environmentally friendly and does not cause depletion of resources. However, the natural energy is limited by a natural geographical condition, and it is difficult to obtain desired generation power depending on weather conditions or places. In the future, it is would be great to be able to use natural energy at sea, in which wind energy or other natural energy sources such as tides and currents are abundant. As a way to overcome this problem, research on green hydrogen production, which produces hydrogen by using offshore wind energy, is currently being actively conducted globally.

In recent years, due to global warming, rain falls locally or over a small time period, and water resources are concentrated in one place geographically or temporally, or due to the reduction of the water retention capacity of mountainous areas caused by forestry decline or deforestation, etc., it is difficult to stably secure water resources. In order to stably secure water resources, there are seawater desalination methods such as a reverse osmosis (RO) method, an adsorption desalination (AD) method, a membrane distillation (MD) method, and an evaporation method (MED, MSF, MVR) that remove salt from seawater. In addition, hydrogen can be produced by using fresh water obtained by using these seawater desalination methods at sea.

An offshore wind power generator has a cooler to prevent a overheating phenomenon caused by power generation. In this case, cold water heat-exchanged by using a cold heat source is heated and discharged as hot water (a waste heat source). This waste heat source can be utilized to produce water through seawater desalination and hydrogen and oxygen through low-temperature electrolysis.

Hereinafter, an exemplary embodiment of the present disclosure will be described in detail with reference to the accompanying drawings so that those skilled in the art to which the present disclosure belongs can easily carry out the present disclosure.

In describing the embodiment, descriptions of technical contents that are well known in the technical field to which the present disclosure belongs and are not directly related to the present disclosure are omitted. This is intended to more clearly convey the gist of the present disclosure without obscuring the gist by omitting unnecessary descriptions.

For the same reason, in the accompanying drawings, some components are exaggerated, omitted, or schematically illustrated. In addition, the size of each component is not a complete representation of its actual size. In each of the drawings, the same reference number is assigned to the same or corresponding component.

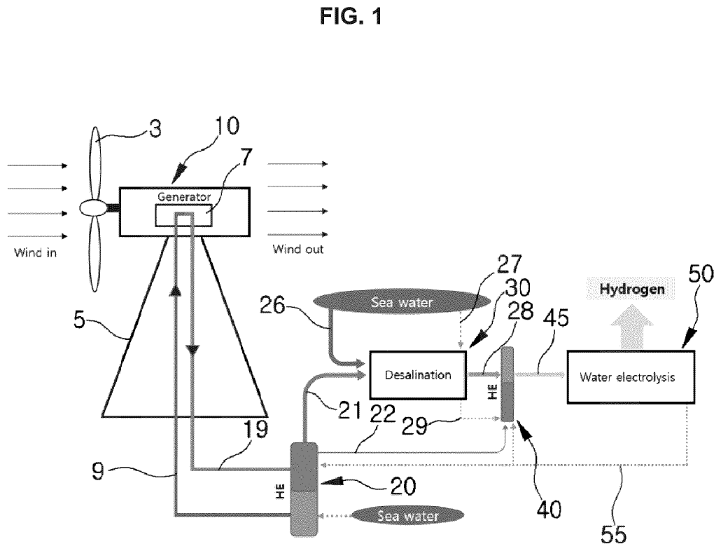

FIG. 1 is a diagram illustrating the configuration of a heat source system utilizing a waste heat source (an unutilized heat source) of a complex system of offshore wind power generation, seawater desalination, and water electrolysis, according to one embodiment of the present disclosure.

Referring to FIG. 1, the complex system of offshore wind power generation, seawater desalination, and water electrolysis according to the embodiment of the present disclosure includes a wind power generator 10 which generates electric power by rotating blades with wind power and includes a cooler for preventing a overheating phenomenon caused by the electric power generation, a seawater desalination apparatus 30 which desalinates seawater by using hot water discharged after heat exchange through the cooler, and a water electrolysis apparatus 50 which receives a heat source discharged after desalination of fresh water in the seawater desalination apparatus 30 to use the heat source for producing hydrogen, wherein a part of the heat source discharged after the desalination of seawater in the seawater desalination apparatus 30 is heat exchanged with hot water discharged from the cooler.

After seawater introduced into a first heat exchanger 20 is warmed through a first low-temperature water flow pipe 9 and a generator and cooler 7 of the wind power generator 10, the seawater is returned through a first high-temperature water flow pipe 19 to the first heat exchanger 20, and then is introduced through the second high-temperature water flow pipe 21 to the seawater desalination apparatus 30, and some of the seawater is introduced into a second heat exchanger 40 to be used as a heat source for producing hydrogen by using the water electrolysis apparatus 50.

In addition, the seawater desalination apparatus 30 directly pumps seawater by using a second low-temperature water flow pipe 26 and a third low-temperature water flow pipe 27 to use the seawater in a desalination process, and after the desalination process is completed, a fluid is supplied to the second heat exchanger 40 through a fourth low-temperature water flow pipe 28 and a discharge pipe 29 of the desalination apparatus.

In addition, the water electrolysis apparatus 50 may receive fluid through a water electrolysis inlet pipe 45 communicating with the second heat exchanger 40 to use the fluid for hydrogen production, and fluids other than hydrogen may be discharged through a water electrolyzer discharge pipe 55 to each of the first heat exchanger 20 and the second heat exchanger 40 to be used as a heat source thereof.

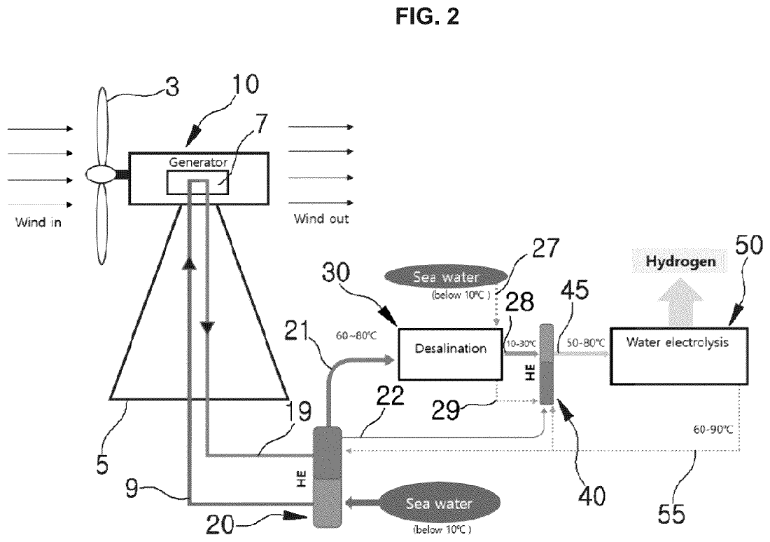

FIG. 2 is a diagram illustrating the system configuration of a membrane distillation (MD) method and an evaporation method (MED, MSF, MVR) among seawater desalination methods applicable to the present disclosure, and the inlet temperature and outlet temperature of a PEM water electrolysis apparatus.

Referring to FIG. 2, the inlet and outlet temperatures of the seawater desalination apparatus 30 and the water electrolysis apparatus 50 are illustrated.

Seawater introduced into the first heat exchanger 20 to cool the wind power generator 10 has a temperature of 10 degrees (° C.) or less for efficient heat exchange, and is supplied to the seawater desalination apparatus 30 by having a temperature of 60 to 80 degrees (° C.) after heat exchange through the generator and cooler 7. In this case, the temperature of seawater directly supplied to the cooling water of the seawater desalination apparatus 30 through the third low-temperature water flow pipe 27 is 10 degrees (° C.) or less, and depending on a situation, a general cooler may be used directly without using a seawater cooling heat source.

Here, water vapor produced through desalination is condensed through a coolant (the cooler) to obtain fresh water (ultrapure water). Depending on a situation, an ultrapure water production device may be additionally used. At this time, the temperature of produced water is about 10 to 30 degrees (° C.).

Here, a seawater desalination method used in the seawater desalination apparatus 30 included in the complex system of offshore wind power generation, seawater desalination, and water electrolysis according to the embodiment of the present disclosure is one of the membrane distillation (MD) method and the evaporation method (MED, MSF, MVR).

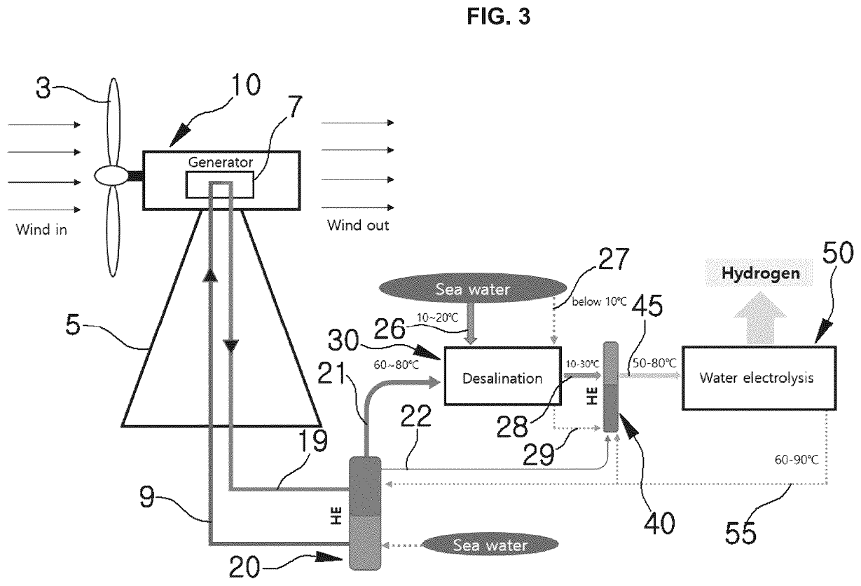

FIG. 3 is a diagram illustrating the system configuration of an adsorption desalination (AD) method among seawater desalination methods applicable to the present disclosure and the inlet temperature and outlet temperature of the PEM water electrolysis apparatus.

Referring to FIG. 3, the seawater desalination apparatus 30 utilizing the adsorption desalination (AD) method introduces seawater (raw water of fresh water) of 10 to 20 degrees (° C.) through the second low-temperature water flow pipe 26, and introduces seawater (cooling water) of 10 degrees (° C.) or less through the third low-temperature water flow pipe 27. Depending on a situation, a general cooler may be used directly without using a seawater cooling heat source.

In addition, cold water of 10 degrees (° C.) or less through the third low-temperature water flow pipe 27 may be used as a water vapor adsorption heat source, and hot water of 60 to 80 degrees (° C.) through a second high-temperature water flow pipe 21 may be used as a desorption heat source for adsorbed water vapor.

Here, water vapor produced through seawater desalination is condensed through a coolant (a cooler) of the third low-temperature water flow pipe 27 to obtain fresh water (ultrapure water), and depending on the quality of fresh water, an ultrapure water production device may be additionally used. In this case, the temperature of produced water is about 10 to 30 degrees (° C.).

In addition, for efficient hydrogen production, ultrapure water is required and the inlet temperature is required to be maintained at 50 to 80 degrees (° C.). Ultrapure water (10 to 30 degrees (° C.)) obtained through seawater desalination is required to be heated to 50 degrees (° C.), and at this time, as a heat source, waste heat from wind power generation, a waste heat source discarded after seawater desalination, and a waste heat source (60 degrees (° C.)) from the water electrolysis apparatus 50 discharged after hydrogen production may be used.

Meanwhile, in this specification and drawings, the exemplary embodiment of the present disclosure is disclosed, and although specific terms are used, these terms are used only in a general sense to easily explain the technical contents of the present disclosure and help understanding of the present disclosure, but are not intended to limit the scope of the present disclosure. It is obvious to those skilled in the art that other modified examples based on the technical idea of the present disclosure in addition to the embodiment disclosed herein may be implemented.

What is claimed is:

1. An offshore wind power generation-seawater desalination-water electrolysis complex system, the system comprising:
a wind power generator configured to generate electric power in such a manner that blades are rotated by wind power, the wind power generator comprising a cooler configured to prevent an overheating phenomenon caused by the electric power generation;
a seawater desalination apparatus configured to desalinate seawater by using hot water discharged after heat exchange through the cooler; and
a water electrolysis apparatus configured to receive fresh water produced by the seawater desalination apparatus and a heat source discharged therefrom to use the fresh water and heat source for producing hydrogen,
wherein a part of a heat source discharged from the water electrolysis apparatus after the production of hydrogen is configured to be heat-exchanged with the cooler and is configured to be heat-exchanged with the heat source discharged from the seawater desalination apparatus.

2. The system of claim 1, wherein the fresh water comprises ultrapure water.

3. The system of claim 1, wherein temperatures of waste heat and seawater used in the system are configured to be preset according to a surrounding environment (a wind power generation capacity and a region, etc.).

4. The system of claim 3, wherein the waste heat comprises heat of hot water used in the system.

5. The system of claim 3, wherein the surrounding environment comprises a wind power generation capacity and a region.

6. The system of claim 1, wherein a seawater desalination method used in the desalination apparatus comprises at least one of an adsorption desalination (AD) method, a membrane distillation (MD) method, or an evaporation method.

7. The system of claim 6, wherein the evaporation method comprises multi-effect distillation (MED), multi-stage flash distillation (MSF), and mechanical vapor recompression (MVR).

8. The system of claim 1, wherein a hydrogen production method used in the water electrolysis apparatus is a low temperature water electrolysis (PEM) method.
